(19) United States
(12) Patent Application Publication
(10) Pub. No.: US 2023/0145390 A1
(43) Pub. Date: May 11, 2023

(54) IMAGE PROCESSING DEVICE, DISPLAY DEVICE, AND IMAGE PROCESSING METHOD

(71) Applicant: SHARP KABUSHIKI KAISHA, Sakai City (JP)

(72) Inventor: TATSUNORI NAKAMURA, Sakai City (JP)

(21) Appl. No.: 17/949,190

(22) Filed: Sep. 20, 2022

Related U.S. Application Data
(60) Provisional application No. 63/277,795, filed on Nov. 10, 2021.

(51) Int. Cl. G09G 3/36; G09G 3/34

(52) U.S. Cl. CPC G09G 3/3607; G09G 3/3413; G09G 2320/0646; G09G 2360/16

(57) ABSTRACT

An image processing device in a display device including a first liquid crystal panel configured to display a first image and a second liquid crystal panel disposed on a back surface of the first liquid crystal panel and configured to display a second image, includes: a first image generation unit configured to generate the first image from an input image in which a fourth image is overlapped on a third image, a first region included in the first image forming the fourth image; a second image generation unit configured to generate the second image from the input image, a second region included in the second image forming the fourth image; and an adjustment unit configured to reduce a luminance in the second region, with an amount of reduction of the luminance in the second region being larger than an amount of reduction of a luminance in the first region.

### CROSS REFERENCE TO RELATED APPLICATION

The present application claims priority from Provisional Application No.63/277,795, the content to which is hereby incorporated by reference into this application.

### BACKGROUND OF THE DISCLOSURE

### 1. Field of the Disclosure

The disclosure relates to an image processing device, a display device, and an image processing method.

### 2. Description of the Related Art

JP 2019-174742 A discloses a liquid crystal display device in which a plurality of liquid crystal panels are arranged in an overlapping manner. In the liquid crystal display device disclosed in JP 2019-174742 A, a second liquid crystal panel arranged on the back surface side of a first liquid crystal panel displays an image using image data obtained by expanding a bright spot signal included in an input video signal.

### SUMMARY

When an image including a plurality of overlapping images is displayed, if the plurality of images are displayed with their luminance uniformly adjusted, the display quality might be compromised due to a noticeable difference in brightness between some of the images displayed and other images. For example, the display quality might be compromised with some of the displayed images being too bright.

In the liquid crystal display device disclosed in JP 2019-174742 A, the bright spot signals are uniformly adjusted for the image displayed on the second liquid crystal panel. Thus, when the liquid crystal display device disclosed in JP 2019-174742 A displays a plurality of videos in an overlapping manner, the display quality might be compromised due to some images in the displayed video being too bright. In view of the above, an object of one aspect of the disclosure is to provide an image processing device, a display device, and an image processing method suppressing the deterioration of the display quality when a plurality of images are displayed in an overlapping manner.

An image processing device according to an aspect of the disclosure in a display device including a first liquid crystal panel configured to display a first image and a second liquid crystal panel that is disposed on a back surface of the first liquid crystal panel and is configured to display a second image, includes: a first image generation unit configured to generate the first image from an input image in which a fourth image is overlapped on a third image, an image in a first region included in the first image forming the fourth image; a second image generation unit configured to generate the second image from the input image, an image in a second region included in the second image forming the fourth image; and an adjustment unit configured to reduce a luminance in the second region in the second image to reduce a luminance of the fourth image, with an amount of reduction of the luminance in the second region being larger than an amount of reduction of a luminance in the first region.

A display device according to an aspect of the disclosure includes: a first liquid crystal panel configured to display the first image; a second liquid crystal panel that is disposed on a back surface of the first liquid crystal panel and is configured to display a second image; and an image processing device. The image processing device includes: a first image generation unit configured to generate the first image from an input image in which a fourth image is overlapped on a third image, an image in a first region included in the first image forming the fourth image; a second image generation unit configured to generate the second image from the input image, an image in a second region included in the second image forming the fourth image; and an adjustment unit configured to reduce a luminance in the second region in the second image to reduce a luminance of the fourth image, with an amount of reduction of the luminance in the second region being larger than an amount of reduction of a luminance in the first region.

An image processing method of generating a first image displayed on a first liquid crystal panel and a second image displayed on a second liquid crystal panel disposed on a back surface of the first liquid crystal panel according to an aspect of the disclosure includes: generating the first image from an input image in which a fourth image is overlapped on a third image, an image in a first region included in the first image forming the fourth image; generating the second image from the input image, an image in a second region included in the second image forming the fourth image; and reducing a luminance in the second region in the second image to reduce the luminance of the fourth image, with an amount of reduction of the luminance in the second region being larger than an amount of reduction of a luminance in the first region.

### BRIEF DESCRIPTION OF DRAWINGS

FIG. 1 is a block diagram illustrating an example of a configuration of a display device according to a first embodiment.

FIG. 2 is an exploded perspective view illustrating an example of a schematic configuration of a first liquid crystal panel, a second liquid crystal panel, and a backlight.

FIG. 3 is a diagram for explaining a first region included in a first image.

FIG. 4 is a diagram for explaining a second region included in a second image.

FIG. 5 is a flowchart illustrating an example of an operation performed by an image processing device according to the first embodiment.

FIG. 6A illustrates an example of a third image.

FIG. 6B illustrates an example of a fourth image.

FIG. 6C illustrates an example of an input image with the fourth image illustrated as an example in FIG. 6B overlapped on the third image illustrated as an example in FIG. 6A.

FIG. 7A illustrates an example of an image obtained by reducing the gray-scale number in the first region in the first image generated from the input image illustrated as an example in FIG. 6C.

FIG. 7B illustrates an example of the second image generated from the input image illustrated as an example in FIG. 6C.

FIG. 7C is a diagram illustrating a comparative example of the display device according to the first embodiment, and illustrates an example of an image in which the image illustrated as an example in FIG. 7A and the second image illustrated as an example in FIG. 7B are overlapped to be viewed.

FIG. 8A illustrates an example of the first image generated from the input image illustrated as an example in FIG. 6C.

FIG. 8B illustrates an example of the second image obtained by reducing the luminance for the second region in the second image generated from the input image illustrated as an example in FIG. 6C.

FIG. 8C is a diagram illustrating an example of an image in which the first image illustrated as an example in FIG. 8A and the second image illustrated as an example in FIG. 8B are overlapped and viewed.

FIG. 9 is a block diagram illustrating an example of a configuration of a display device according to a modified example of the first embodiment.

FIG. 10 is a block diagram illustrating an example of a configuration of a display device according to a second embodiment.

FIG. 11 is a flowchart illustrating an example of an operation performed by the display device according to the second embodiment.

FIG. 12 is a block diagram illustrating an example of a configuration of a display device according to a modified example of the second embodiment.

### DETAILED DESCRIPTION OF THE DISCLOSURE

### First Embodiment

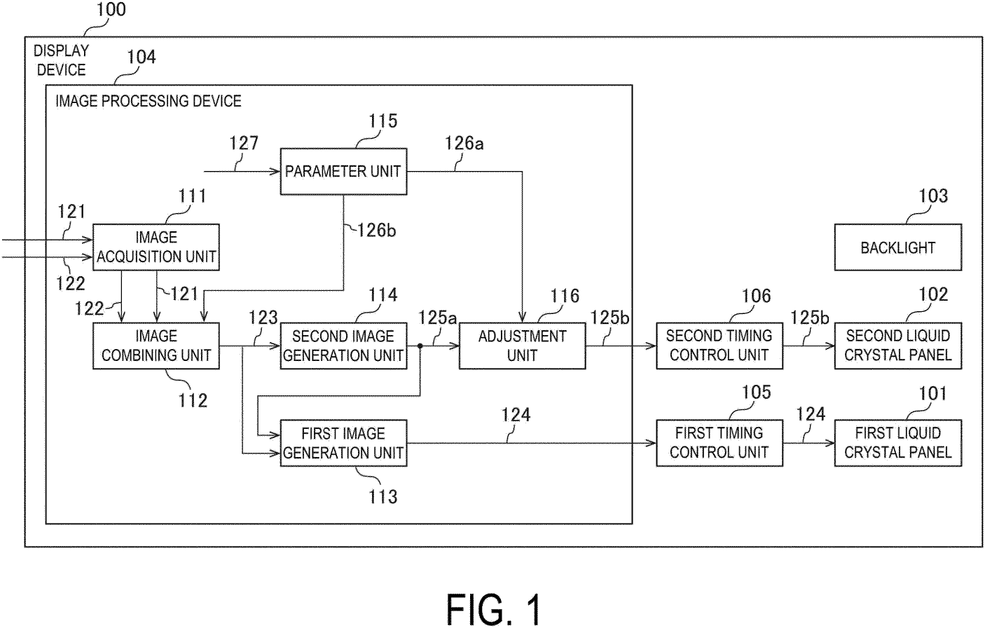

A first embodiment will be described with reference to FIG. 1 to FIG. 8C. Note that, in the drawings, identical or equivalent elements are given an identical reference sign, and redundant descriptions thereof may be omitted.

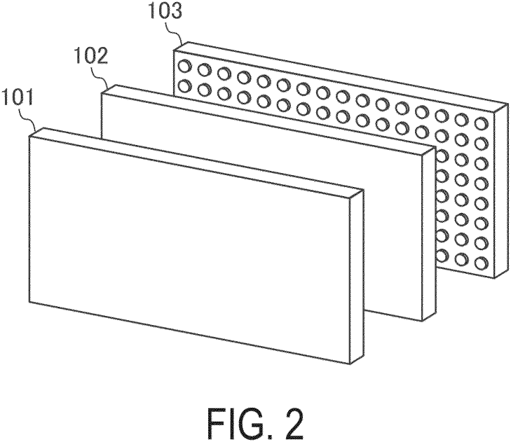

FIG. 1 is a block diagram illustrating an example of a configuration of a display device 100 according to the present embodiment. The display device 100 includes a first liquid crystal panel 101, a second liquid crystal panel 102, a backlight 103, an image processing device 104, a first timing control unit 105, and a second timing control unit 106. FIG. 2 is an exploded perspective view illustrating an example of a schematic configuration of the first liquid crystal panel 101, the second liquid crystal panel 102, and the backlight 103.

The first liquid crystal panel 101 is a liquid crystal panel having a display region for displaying various images, where a plurality of pixels are arranged in a matrix. The first liquid crystal panel 101 drives the liquid crystals by an electric field generated by voltage supplied to each pixel. The first liquid crystal panel 101 displays an image, by controlling the light transmittance of the backlight 103 in the liquid crystals driven. The first liquid crystal panel 101 includes subpixels of RGB (red, green, and blue).

The second liquid crystal panel 102 is a liquid crystal panel having a display region for displaying various images, where a plurality of pixels are arranged in a matrix. The second liquid crystal panel 102 drives the liquid crystals by an electric field generated by a voltage supplied to each pixel. The second liquid crystal panel 102 displays an image, by controlling the light transmittance of the backlight 103 in the liquid crystals driven. The maximum gray-scale number displayable by the second liquid crystal panel 102 may be lower than that displayable by the first liquid crystal panel 101. For example, the second liquid crystal panel 102 includes a subpixel of W (white) without including the subpixels of RGB. The second liquid crystal panel 102 may include the subpixels of RGB (red, green, and blue). The resolution of the second liquid crystal panel 102 and the resolution of the first liquid crystal panel 101 may be the same or different. For example, the resolution of the second liquid crystal panel 102 is lower than the resolution of the first liquid crystal panel 101.

The second liquid crystal panel 102 is disposed on the back surface of the first liquid crystal panel 101 as viewed from the user side, and is disposed to overlap with the first liquid crystal panel 101. Thus, the second liquid crystal panel 102 is disposed on the back surface side of the display surface of the first liquid crystal panel 101, while overlapping with the first liquid crystal panel 101.

The backlight 103 is disposed on the back surface side of the display surface of the second liquid crystal panel 102 to overlap with the second liquid crystal panel 102, and is an illumination device that planarly illuminates the first liquid crystal panel 101 and the second liquid crystal panel 102.

The second liquid crystal panel 102 is disposed between the first liquid crystal panel 101 and the backlight 103, to modulate the light from the backlight 103, and illuminate the first liquid crystal panel 101. Thus, the first liquid crystal panel 101 receives the light modulated by the second liquid crystal panel 102, and thus can display an image with a high contrast.

The image processing device 104 adjusts the luminance of a first image 124 displayed on the first liquid crystal panel 101 and the luminance of a second image 125b displayed on the second liquid crystal panel 102. The image processing device 104 is implemented, for example, by a circuit such as an Application Specific Integrated Circuit (ASIC) or a Field-Programmable Gate Array (FPGA). In the disclosure, the image is two-dimensional data including RGB pixel data In the disclosure, the luminance is a value indicating the brightness obtained with pixels lit.

The image processing device 104 includes an image acquisition unit 111, an image combining unit 112, a first image generation unit 113, a second image generation unit 114, a parameter unit 115, and an adjustment unit 116.

The image acquisition unit 111 acquires a third image 121 included in one video and a fourth image 122 included in another video. In the disclosure, the video is a signal indicating a plurality of images in time series.

The image combining unit 112 uses mask region information 126b described below, to generate an input image 123 with the fourth image 122 overlapped on the third image 121.

The first image generation unit 113 generates the first image 124 from the input image 123. An image in a first region included in the first image 124 forms the fourth image 122. An image outside the first region included in the first image 124 forms the third image 121

The second image generation unit 114 generates a second image 125a from the input image 123. An image in a second region included in the second image 125a forms the fourth image 122. An image outside the second region included in the second image 125a forms the third image 121.

The parameter unit 115 holds mask region information 126a and the mask region information 126b. The mask region information 126a and the mask region information 126b indicate the position and the size of the second region. The mask region information 126a and the mask region information 126b may be, for example, (1) coordinates at the upper left and lower right of the second region, or (2) coordinates at the upper left of the second region and the width and height of the second region. The mask region information 126a and the mask region information 126b may be the same or may be different from each other. For example, the mask region information 126a may be the information (1) and the mask region information 126b may be the information (2), or the mask region information 126a and the mask region information 126b may both be the information (1). The mask region information 126a and the mask region information 126b may be hereinafter collectively referred to as mask region information 126. Upon acquiring control information 127 indicating the position and size of the second region, the parameter unit 115 changes the mask region information 126 based on the position and size indicated by the control information 127.

The adjustment unit 116 uses the mask region information 126a to reduce the luminance in the second region in the second image 125a, and thus reduces the luminance of the fourth image 122.

The first timing control unit 105 drives the first liquid crystal panel 101. The first timing control unit 105 controls the timing at which the first image 124 is displayed on the first liquid crystal panel 101.

The second timing control unit 106 drives the second liquid crystal panel 102. The second timing control unit 106 controls the timing at which the second image 125b with the luminance in the second region reduced is displayed on the second liquid crystal panel 102.

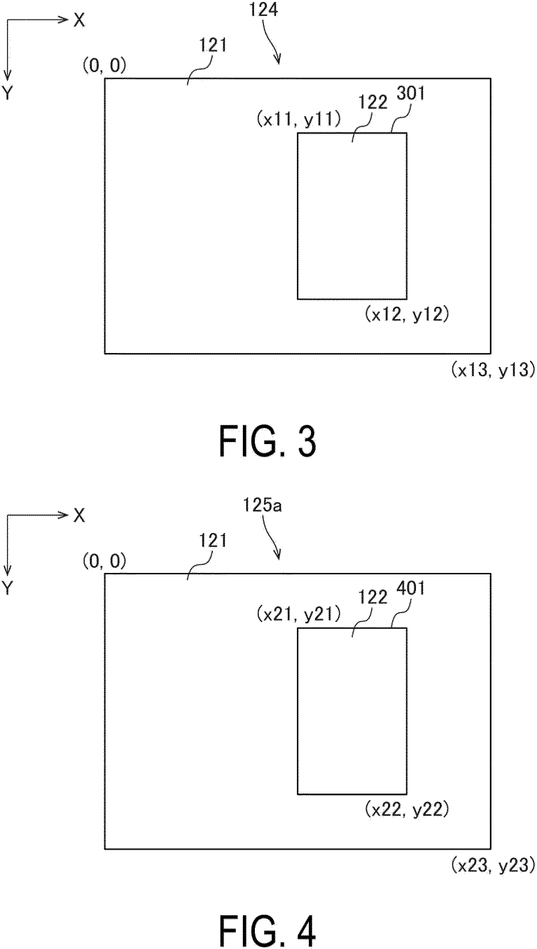

FIG. 3 is a diagram for explaining a first region 301 included in the first image 124. Pixel coordinates in a horizontal direction and a vertical direction of the first image 124 are defined as x1 and y1. Under this condition, the coordinates of the pixel at the upper left end of the first image 124 are (x1,y1) = (0,0). The coordinates of the pixel at the lower right end of the first image 124 are (x1,y1) = (x13,y13). The coordinates of the pixel at the upper left end of the first region 301 included in the first image 124 are (x1,y1) = (x11,y11). The coordinates of the pixel at the lower right end of the first region 301 are (x1,y1) = (x12,y12). The fourth image 122 is formed in a range of x11 ≤ x1 ≤ x12 and y11 ≤ y1 ≤ y12, which is in the first region 301. On the other hand, in the first image 124, the third image 121 is configured in the range outside the first region 301.

FIG. 4 is a diagram for explaining a second region 401 included in the second image 125a. Pixel coordinates in a horizontal direction and a vertical direction of the second image 125a are respectively defined as x2 and y2. Under this condition, the coordinates of the pixel at the upper left end of the second image 125a are (x2,y2) = (0,0). The coordinates of the pixel at the lower right end of the second image 125a are (x2,y2) = (x23,y23) The coordinates of the pixel at the upper left end of the second region 401 included in the second image 125a are (x2,y2) = (x21,y21). The coordinates of the pixel at the lower right end of the second region 401 are (x2,y2) = (x22,y22). The fourth image 122 is formed in a range of x21 ≤ x2 ≤ x22 and y21 ≤ y2 ≤ y22, which is in the second region 401. On the other hand, in the second image 125a, the third image 121 is configured in the range outside the second region 401.

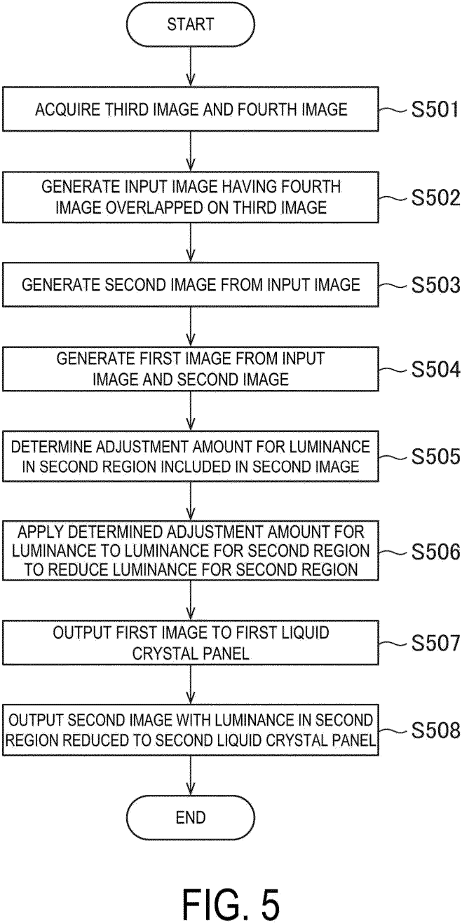

FIG. 5 is a flowchart illustrating an example of an operation performed by the image processing device 104 according to the present embodiment.

In step S501, the image acquisition unit 111 acquires the third image 121 included in one video and the fourth image 122 included in another video.

In step S502, the image combining unit 112 generates the input image 123 with the fourth image 122 acquired in step S501 overlapped on the third image 121 acquired in step S501.

In step S503, the second image generation unit 114 generates the second image 125a from the input image 123. Specifically, the second image generation unit 114 converts the input image 123 into an image with a resolution displayable on the second liquid crystal panel 102, and then executes filter processing based on a viewing angle to generate the second image 125a.

In step S504, the first image generation unit 113 generates the first image 124 from the input image 123 and the second image 125a. Specifically, the first image generation unit 113 multiplies the light transmittance of the first liquid crystal panel by the light transmittance of the second liquid crystal panel, to generate the first image 124 in such a manner that the input image is displayed upon being lit by the backlight. For example, the first image 124 is an image with pixels each indicating the pixel value of a first gray-scale number of a red component R, a green component G, and a blue component B. In the disclosure, the pixel value is a data value representing the brightness of each pixel.

In step S505, the adjustment unit 116 determines an adjustment amount a for the luminance in the second region 401 included in the second image 125a. Note that the adjustment unit 116 determines the position and the size of the second region 401 based on the mask region information 126. For example, the adjustment unit 116 acquires the set adjustment amount α to determine the adjustment amount a for the luminance in the second region 401 included in the second image 125a.

Alternatively, the adjustment unit 116 may acquire the adjustment amount a input from the outside of the display device 100. For example, when the user uses a button, a remote controller, and the like provided with the display device 100 to input the adjustment amount α, the adjustment unit 116 determines the adjustment amount α for the luminance in the second region 401 included in the second image 125a by acquiring the adjustment amount α thus input.

Alternatively, the adjustment unit 116 may determine the adjustment amount a for the luminance of each pixel in the second region 401 based on the luminance of each pixel in the second region 401. For example, the adjustment unit 116 calculates the adjustment amount α for the luminance by using a formula for the adjustment amount α = f (Yᵢ₂(x2,y2)) for the luminance. The luminance Yᵢ₂(x2,y2) indicates the luminance corresponding to a coordinate value (x2,y2) in the second image 125a. The function f is a formula for calculating the adjustment amount a for the luminance from the luminance Yᵢ₂(x2,y2). The adjustment unit 116 substitutes the luminance Yᵢ₂(x2,y2) in the function f to calculate the adjustment amount a for the luminance.

In step S506, the adjustment unit 116 applies the adjustment amount a for the luminance determined in step S505 to the luminance Yᵢ₂(x2,y2) in the second region 401, and thus reduces the luminance Yᵢ₂(x2,y2) in the second region 401. The adjustment unit 116 reduces the luminance Yᵢ₂(x2,y2) in the second region 401 to reduce the luminance of the fourth image 122 included in the second image 125a. For example, the adjustment unit 116 applies the set adjustment amount α to the luminance Yᵢ₂(x2,y2) in the second region 401 to reduce the luminance Yᵢ₂(x2,y2) in the second region 401, and thus reduces the luminance of the fourth image 122 included in the second image 125a.

It is assumed that the adjustment unit 116 has alternatively acquired the adjustment amount α input from the outside. In this case, the adjustment unit 116 applies the adjustment amount a for the luminance input from the outside to the luminance Yᵢ₂(x2,y2) in the second region 401, and thus reduces the luminance Yᵢ₂(x2,y2) in the second region 401.

It is assumed that the adjustment unit 116 has alternatively determined the adjustment amount α for the luminance of each pixel in the second region 401 based on the luminance Yᵢ₂(x2,y2) of each pixel in the second region 401. In this case, the adjustment unit 116 applies the adjustment amount a for the luminance of each pixel in the second region 401 determined based on the luminance Yᵢ₂(x2,y2) of each pixel in the second region 401, to the luminance Yᵢ₂(x2,y2) of each pixel in the second region 401, to reduce the luminance Yᵢ₂(x2,y2) in the second region 401. For example, the adjustment unit 116 multiplies the luminance Yᵢ₂(x2,y2) of each pixel in the second region 401 by the adjustment amount α calculated, to reduce the luminance of each pixel in the second region 401. In this manner, the adjustment unit 116 reduces the luminance of each pixel in the second region 401, based on the luminance of each pixel in the fourth image 122.

When the adjustment amount α < 1 for the luminance, x21 ≤ x ≤ x22, and y21 ≤ y ≤ y22 hold, the luminance Y_{O2}(x2,y2) = α × Yᵢ₂(x2,y2) holds The luminance Y_{O2} is the luminance of the pixel at the coordinates (x2,y2) included in the second image 125b displayed on the second liquid crystal panel 102. Thus, the luminance outside the second region 401 included in the second image 125b is lower than the luminance outside the second region 401 included in the second image 125a. On the other hand, when x2 < x21 or x2 > x22 holds or y2 < y21 or y2 > y22 holds, Y_{O2}(x2,y2) = Yᵢ₂(x2,y2) holds. Thus, the luminance outside the second region 401 included in the second image 125b is the same as the luminance outside the second region 401 included in the second image 125a.

In step S507, the first timing control unit 105 outputs the first image 124 generated in step S504, to the first liquid crystal panel 101.

In step S508, the second timing control unit 106 outputs the second image 125b with the luminance in the second region 401 reduced in step S506, to the second liquid crystal panel 102.

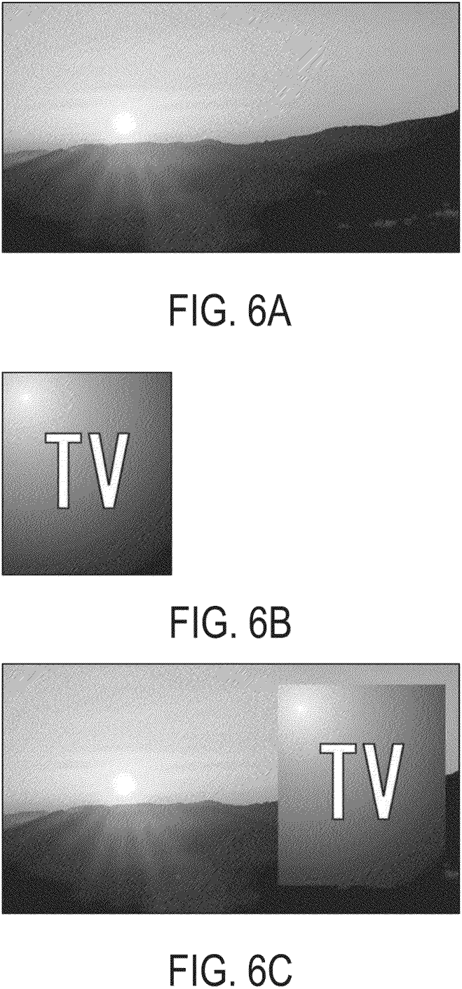

FIG. 6A to FIG. 6C are diagrams illustrating examples of the third image 121, the fourth image 122, and the input image 123. FIG. 6A illustrates an example of the third image 121. FIG. 6B illustrates an example of the fourth image 122. FIG. 6C illustrates an example of the input image 123 with the fourth image 122 illustrated as an example in FIG. 6B overlapped on the third image 121 illustrated as an example in FIG. 6A.

For example, the third image 121 is an image with the gray-scale number of each of the red component, the green component, and the blue component being eight bits. In this case, in the brightest portion in the third image 121, the pixel value of each of the red component, the green component, and the blue component is 255. For example, the fourth image 122 is an image with the gray-scale number of each of the red component, the green component, and the blue component being eight bits. In this case, in the brightest portion in the fourth image 122, the pixel value of each of the red component, the green component, and the blue component is 255.

In the input image 123 illustrated as an example in FIG. 6C, the luminance is the same between the brightest portion of the third image 121 and the brightest portion of the fourth image 122. For example, when the input image 123 illustrated as an example in FIG. 6C is input to be displayed on a liquid crystal panel with a maximum luminance of 1000 nits, the luminance of the brightest portions of the third image 121 and the fourth image 122 is 1000 nits. In this case, the fourth image 122 displayed on the liquid crystal panel could be too bright, and thus could be an image with low visibility.

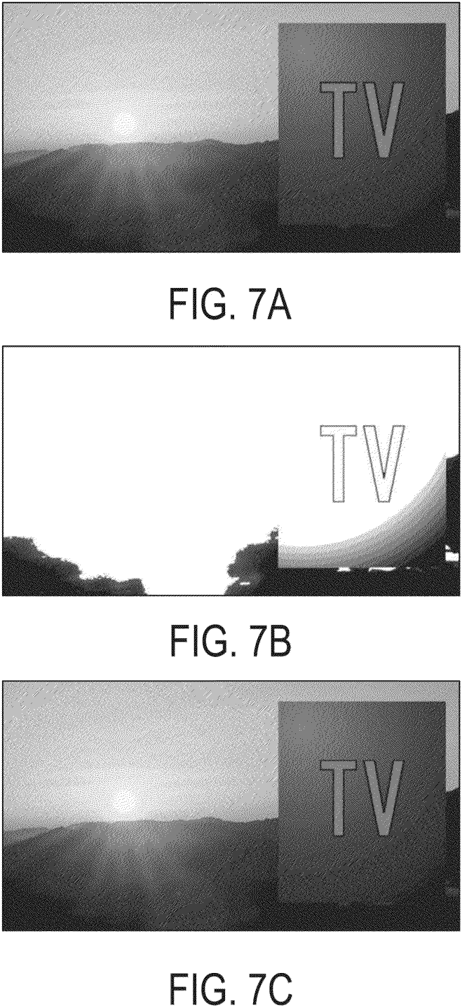

FIG. 7A to FIG. 7C are diagrams illustrating a comparative example corresponding to a case where the processing of the present embodiment is not applied. FIG. 7A illustrates an example of the first image 124, generated from the input image 123 illustrated as an example in FIG. 6C, with the gray-scale number of the first region 301 reduced, to make the fourth image 122 darker and easier to view FIG. 7B illustrates an example of the second image 125a generated from the input image 123 illustrated as an example in FIG. 6C. FIG. 7C is a diagram illustrating an example of an image in which the first image 124 illustrated as an example in FIG. 7A and the second image 125a illustrated as an example in FIG. 7B are overlapped and viewed.

The reduction of the gray-scale number for the first region 301 included in the first image 124 can solve the problem of the fourth image 122 becoming too bright but leads to another problem. Specifically, the effective gray-scale number in a region forming the fourth image 122 is reduced and a false contour becomes visible in a gray-scale portion in the fourth image 122 as illustrated as an example in FIG. 7C. As a result, the display quality is compromised compared with that of the fourth image 122 illustrated as an example in FIG. 6C. Considering the above, the reduction of the gray-scale number for the first region 301 included in the first image 124 might result in an image that is difficult to view due to the display quality being relatively compromised.

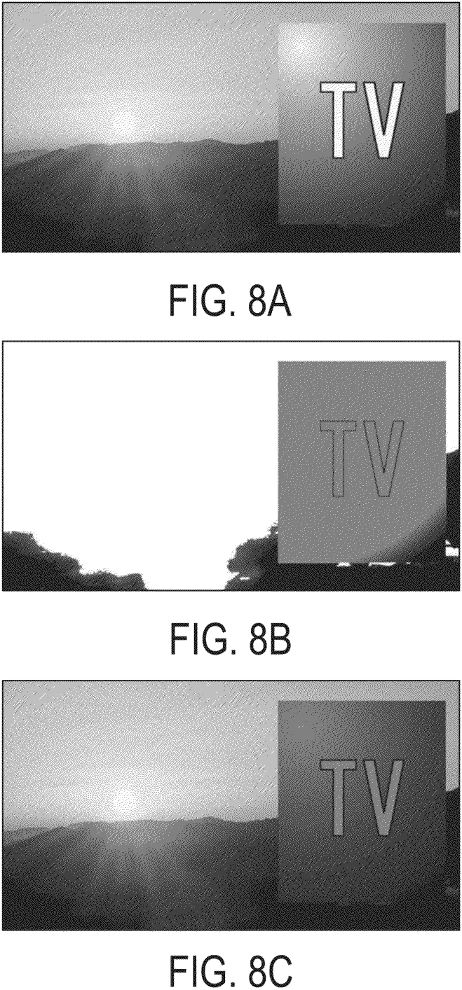

FIG. 8A to FIG. 8C are diagrams illustrating an example of processing executed by the image processing device 104 according to the present embodiment. FIG. 8A illustrates an example of the first image 124 generated from the input image 123 illustrated as an example in FIG. 6C. FIG. 8B illustrates an example of the second image 125b obtained by reducing the luminance of the second region 401 in the second image 125a generated from the input image 123 illustrated as an example in FIG. 6C. FIG. 8C is a diagram illustrating an example of an image in which the first image 124 illustrated as an example in FIG. 8A and the second image 125b illustrated as an example in FIG. 8B are overlapped and viewed.

As illustrated as an example in FIG. 8C, the display device 100 reduces the luminance of the second region 401 in the second image 125b displayed on the second liquid crystal panel 102, without changing the gray-scale number of the first region 301 included in the first image 124 displayed on the first liquid crystal panel 101. When the display device 100 reduces the luminance of the second region 401 included in the second image 125b displayed on the second liquid crystal panel 102 as illustrated as an example in FIG. 8C, the change in the gray scale in a region forming the fourth image 122 can be made smooth in the image viewed. Furthermore, the display device 100 does not change the gray-scale number of the first region 301 included in the first image 124. Thus, the deterioration of the display quality can be suppressed for a region forming the fourth image 122 as illustrated as an example in FIG. 8C.

Furthermore, the display device 100 can reduce a difference in brightness between a region forming the third image 121 and a region forming the fourth image 122 in an image viewed, as illustrated as an example in FIG. 8C. According to such effects, the display device 100 has two liquid crystal display panels overlapping, to improve the contrast of an image viewed and to reduce the luminance of the second region 401 included in the second image 125b, whereby deterioration of the display quality due to overlapping display of a plurality of images can be suppressed, so that an image that is easy to view by the user can be displayed.

In the present embodiment, the adjustment unit 116 reduces the luminance of the fourth image 122 by reducing the luminance in the second region 401 included in the second image 125a, but does not execute processing of reducing the luminance for the first region 301 included in the first image 124. In the processing executed by the image processing device 104 according to the present embodiment, the amount of reduction of the luminance in the second region 401 can be regarded as being larger than the amount of reduction of the luminance in the first region 301. This allows the image processing device 104 according to the present embodiment to display the first region 301 included in the first image 124 without reducing the gray-scale range while reducing the display luminance of the fourth image 122, whereby generation of a false contour can be suppressed so that the deterioration of the display quality can be suppressed.

### Modified Example

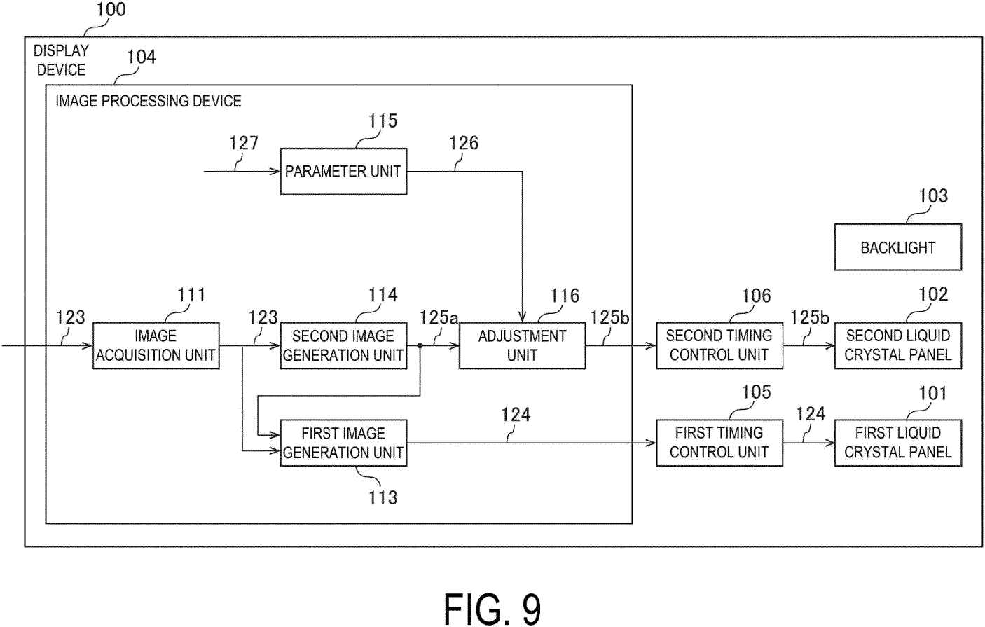

As a modified example of the present embodiment, the input image 123 in which the fourth image 122 is overlapped on the third image 121 may be input to the image processing device 104. FIG. 9 is a block diagram illustrating an example of a configuration of a display device 100 according to the present modified example. The configuration of the display device 100 illustrated as an example in FIG. 9 is different from the configuration of the display device 100 illustrated as an example in FIG. 1, in that the display device 100 illustrated as an example in FIG. 9 does not include the image combining unit 112. In the display device 100 according to the present modified example, the input image 123 is input from the outside of the image processing device 104 to the first image generation unit 113 and the second image generation unit 114.

When the input image 123 in which the fourth image 122 is overlapped on the third image 121 is input, the display device 100 according to the present modified example reduces the luminance of the second region 401 included in the second image 125a to reduce the luminance of the fourth image 122 included in the second image 125a. The luminance for a region forming the fourth image 122, which is a part of the input image 123, is adjusted. With this configuration, even when the input image 123 in which the fourth image 122 is overlapped on the third image 121 is input, the display device 100 according to the present modified example can suppress the deterioration of the display quality due to the overlapping display of the plurality of images.

### Second Embodiment

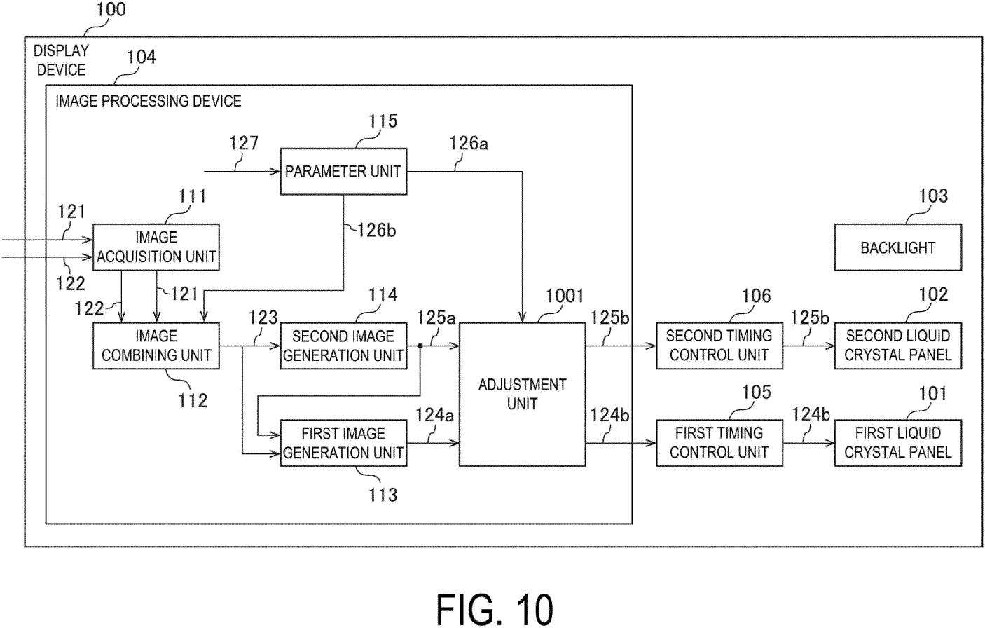

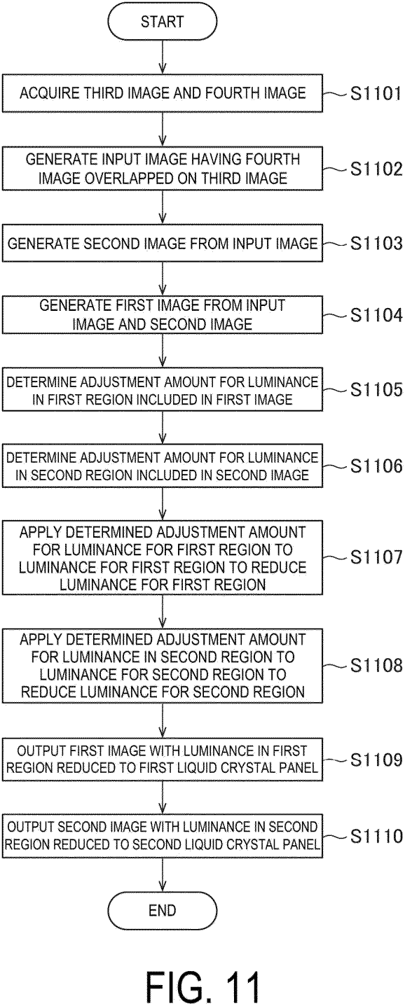

A second embodiment will be described with reference to FIG. 10 and FIG. 11. Note that, in the drawings, identical or equivalent elements are given an identical reference sign, and redundant descriptions thereof may be omitted. The configurations and processes having substantially the same functions as in the first embodiment are denoted by the same reference numerals and the descriptions thereof will be omitted. Differences from the first embodiment will be described.

FIG. 10 is a block diagram illustrating an example of a configuration of a display device 100 according to the present embodiment. The display device 100 illustrated as an example in FIG. 10 is different from the display device 100 illustrated as an example in FIG. 1 in that the display device 100 illustrated as an example in FIG. 10 includes an adjustment unit 1001 instead of the adjustment unit 116.

The mask region information 126a and the mask region information 126b according to the present embodiment indicate the positions and sizes of the first region 301 and the second region 401. The mask region information 126a and the mask region information 126b according to the present embodiment may be, for example, (1) the coordinates at the upper left and lower right of the first region 301 and the second region 401, or (2) the coordinates at the upper left of the first region 301 and the second region 401, and the widths and the heights of the first region 301 and the second region 401. The mask region information 126a and the mask region information 126b may be the same or may be different from each other. For example, the mask region information 126a may be the information (1) and the mask region information 126b may be the information (2), or the mask region information 126a and the mask region information 126b may both be the information (1). Upon acquiring the control information 127 indicating the positions and sizes of the first region 301 and the second region 401, the parameter unit 115 changes the mask region information 126 based on the position and size indicated by the control information 127.

The adjustment unit 1001 uses the mask region information 126a to reduce the luminance in the first region 301 in a first image 124a, and thus reduces the luminance of the fourth image 122 included in the first image 124a. Furthermore, the adjustment unit 1001 reduces the luminance of the fourth image 122 included in the second image 125a by reducing the luminance in the second region 401 in the second image 125a Specifically, the adjustment unit 1001 reduces the luminance in the first region 301 and the luminance in the second region 401, with the amount of reduction of the luminance in the second region 401 being larger than the amount of reduction of the luminance in the first region 301.

FIG. 11 is a flowchart illustrating an example of an operation performed by the display device 100 according to the present embodiment. The processes in steps S1101 to S1104 illustrated as an example in FIG. 11 are the same as those in steps S501 to S504 illustrated as an example in FIG. 5, and thus detailed descriptions thereof will be omitted.

In step S1105, the adjustment unit 1001 determines an adjustment amount α1 for the luminance in the first region 301. In step S1106, the adjustment unit 1001 determines an adjustment amount a2 for the luminance in the second region 401.

In step S1107, the adjustment unit 1001 applies the adjustment amount α1 for the luminance in the first region 301, determined in step S1105, to the luminance Yᵢ₁(x1,y1) in the first region 301 included in the first image 124a to reduce the luminance Yᵢ₁(x1,y1) in the first region 301. Note that the adjustment unit 1001 determines the position and size of the first region 301 based on the mask region information 126. The adjustment unit 1001 reduces the luminance Yᵢ₁(x1,y1) in the first region 301 to reduce the luminance of the fourth image 122 included in the first image 124a.

For example, the adjustment unit 1001 applies the set adjustment amount α1 for the luminance to the luminance Yᵢ₁(x1,y1) in the first region 301, and thus reduces the luminance Yᵢ₁(x1,y1) in the first region 301. Alternatively, the adjustment unit 1001 may apply the adjustment amount α1 for the luminance input from the outside to the luminance in the first region 301, and thus reduce the luminance Yᵢ₁(x1,y1) in the first region 301. Alternatively, the adjustment unit 1001 may apply the adjustment amount α1 for the luminance of each pixel in the first region 301 determined based on the luminance Yᵢ₁(x1,y1) of each pixel in the first region 301, to the luminance Yᵢ₁(x1,y1) of each pixel in the first region 301, and thus reduce the luminance Yᵢ₁(x1,y1) in the first region 301.

Specifically, when the adjustment amount α1 ≤ 1 for the luminance in the first region 301 holds and x11 ≤ x ≤ x12 and y11 ≤ y ≤ y12 hold, the luminance Y_{O1}(x1,y1)= a1 × Yᵢ₁(x1,y1) holds. The luminance Yoi is the luminance of the pixel at the coordinates (x1,y1) included in a first image 124b. Thus, the luminance in the first region 301 of the first image 124b is not higher than the luminance in the first region 301 of the first image 124a. On the other hand, when x1 < x11 or x1 > x12 holds or y1 < y11 or y1 > y12 holds, Y_{O1}(x1,y1) = Yᵢ₁(x1,y1) holds. Thus, the luminance outside the first region 301 of the first image 124b is the same as the luminance outside the first region 301 of the first image 124a. Note that when the adjustment amount α = 1 for the luminance in the first region 301 holds, the first image 124b is the same as the first image 124a.

In step S1108, the adjustment unit 1001 applies the adjustment amount a2 for the luminance in the second region 401, determined in step S1106, to the luminance Yᵢ₂(x2,y2) in the second region 401 included in the second image 125a, and thus reduces the luminance Yᵢ₂(x2,y2) in the second region 401. Note that the adjustment unit 1001 determines the position and size of the second region 401 based on the mask region information 126. The adjustment unit 1001 reduces the luminance of the fourth image 122 included in the second image 125a by reducing the luminance Yᵢ₂(x2,y2) of the second region 401.

For example, the adjustment unit 1001 applies the set adjustment amount α2 for the luminance to the luminance in the second region 401, and thus reduces the luminance Yᵢ₂(x2,y2) in the second region 401. Alternatively, the adjustment unit 1001 may apply the adjustment amount α2 for the luminance input from the outside to the luminance Yᵢ₂(x2,y2) in the second region 401, and thus reduce the luminance Yᵢ₂(x2,y2) in the second region 401. Alternatively, the adjustment unit 1001 may apply an adjustment amount α2 for the luminance of each pixel in the second region 401, determined in accordance with the luminance Yᵢ₂(x2,y2) of each pixel in the second region 401 to the luminance Yᵢ₂(x2,y2) of each pixel in the second region 401, and thus reduce the luminance Yᵢ₂(x2,y2) in the second region 401. In the adjustment unit 1001, when the product of the adjustment amount α1 for the luminance in the first region 301 and the adjustment amount α2 for the luminance in the second region 401 matches the adjustment amount a for the luminance in the first embodiment, the viewed display quality achieved by the display device 100 of the present embodiment is equivalent to the viewed display quality achieved by the display device 100 of the first embodiment When the adjustment amount α1 for the luminance in the first region 301 is set to be 1 and the adjustment amount α2 for the luminance in the second region 401 is set to be the adjustment amount α for the luminance in the first embodiment with the adjustment unit 1001, the processing result obtained by the display device 100 of the present embodiment is the same as the processing result obtained by the display device 100 of the first embodiment.

Furthermore, the adjustment unit 1001 reduces the luminance in the first region 301 and the luminance in the second region 401, with the amount of reduction of the luminance in the second region 401 being larger than the amount of reduction of the luminance in the first region 301. Thus, the adjustment unit 1001 can suppress reduction of the effective gray-scale number of a region forming the fourth image 122 in the first image 124b displayed on the first liquid crystal panel 101.

In step S1109, the first timing control unit 105 outputs the first image 124b with the luminance of the first region 301 reduced in step S1107, to the first liquid crystal panel 101.

In step S1110, the second timing control unit 106 outputs the second image 125b with the luminance in the second region 401 in the fourth image 122 reduced in step S1108, to the second liquid crystal panel 102.

In the present embodiment, as described above, the adjustment unit 1001 reduces the luminance in the first region 301 and the luminance in the second region 401, with the amount of reduction of the luminance in the second region 401 in the second image 125b being larger than the amount of reduction of the luminance in the first region 301 in the first image 124b. With this configuration, the image processing device 104 according to the present embodiment can display the first region 301 included in the first image 124b with a wider gray-scale range than the second region 401 in the second image 125b while reducing the display luminance of the fourth image 122, whereby generation of a false contour can be suppressed, and the deterioration of the display quality can be suppressed.

As described above, the display device 100 reduces the luminance of the fourth image 122 with the amount of reduction of the luminance for the second region 401 included in the second image 125b being larger than the amount of reduction of the luminance for the first region 301 included in the first image 124b, and thus can suppress the deterioration of the display quality due to overlapping display of a plurality of images, and can display an image that is easy to view.

### Modified Example

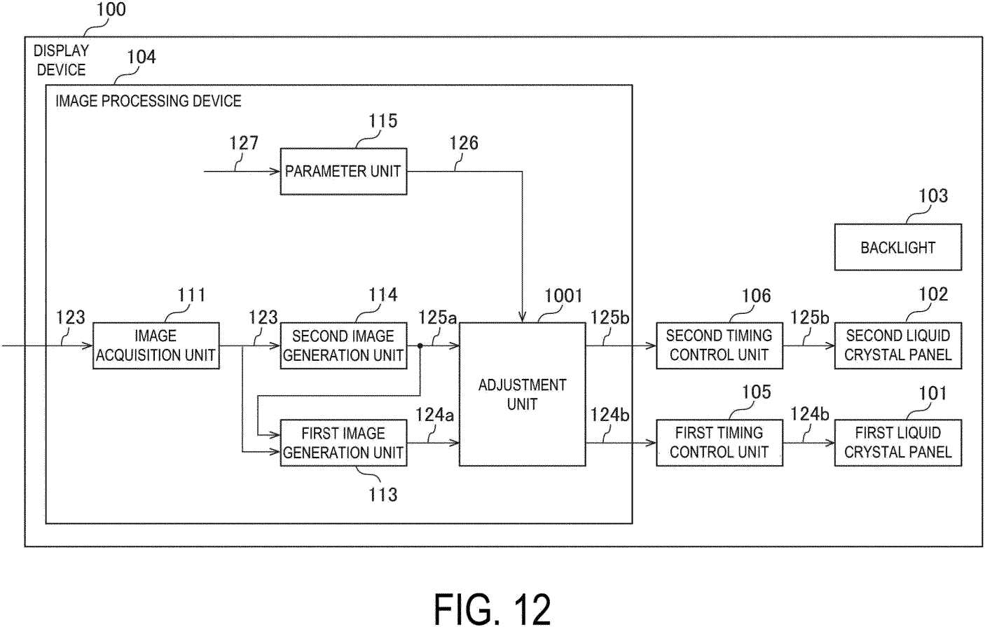

In a modified example of the present embodiment, the input image 123 may be input to the image processing device 104. FIG. 12 is a block diagram illustrating an example of a configuration of a display device 100 according to the present modified example. The configuration of the display device 100 illustrated as an example in FIG. 12 is different from the configuration of the display device 100 illustrated as an example in FIG. 1, in that the display device 100 illustrated as an example in FIG. 12 does not include the image combining unit 112. In the display device 100 according to the present modified example, the input image 123 is input from the outside of the image processing device 104 to the first image generation unit 113 and the second image generation unit 114.

When the input image 123 is input, the display device 100 according to the present modified example reduces the luminance of the fourth image 122, with the amount of reduction of the luminance for the second region 401 included in the second image 125b being larger than the amount of reduction of the luminance for the first region 301 included in the first image 124b. With this configuration, the display device 100 according to the present modified example can suppress the deterioration of the display quality due to the overlapping display of a plurality of images, and thus can display an image that is easy to view

The disclosure is not limited to each of the embodiments described above, and various modifications may be made within the scope of the claims. Embodiments obtained by appropriately combining technical approaches disclosed in each of the different embodiments also fall within the technical scope of the present invention. Moreover, novel technical features may be formed by combining the technical approaches disclosed in each of the embodiments.

What is claimed is:

1. An image processing device in a display device including a first liquid crystal panel configured to display a first image and a second liquid crystal panel that is disposed on a back surface of the first liquid crystal panel and is configured to display a second image, the image processing device comprising:
a first image generation unit configured to generate the first image from an input image in which a fourth image is overlapped on a third image, an image in a first region included in the first image forming the fourth image;
a second image generation unit configured to generate the second image from the input image, an image in a second region included in the second image forming the fourth image; and
an adjustment unit configured to reduce a luminance in the second region in the second image to reduce a luminance of the fourth image, with an amount of reduction of the luminance in the second region being larger than an amount of reduction of a luminance in the first region.

2. The image processing device according to claim 1,
wherein the adjustment unit reduces the luminance of the fourth image by reducing the luminance in the first region in the first image.

3. The image processing device according to claim 1,
wherein the adjustment unit reduces the luminance of the fourth image by reducing the luminance in the second region in the second image, without reducing the luminance in the first region in the first image.

4. The image processing device according to claim 1,
wherein the adjustment unit applies an adjustment amount input from outside to the luminance in the second region to reduce the luminance in the second region.

5. The image processing device according to claim 1,
wherein the adjustment unit applies a set adjustment amount to the luminance in the second region to reduce the luminance in the second region.

6. The image processing device according to claim 1,
wherein the adjustment unit determines an amount of reduction of a luminance of each pixel in the second region based on the luminance of each pixel in the second regi on.

7. The image processing device according to claim 1,
wherein the first image has a first gray-scale number and forms an image in the first region, the second image has a second gray-scale number smaller than the first gray-scale number, and forms an image in the second region.

8. A display device comprising:
a first liquid crystal panel configured to display the first image;
a second liquid crystal panel that is disposed on a back surface of the first liquid crystal panel and is configured to display a second image; and
the image processing device described in claim 1.

9. An image processing method of generating a first image displayed on a first liquid crystal panel and a second image displayed on a second liquid crystal panel disposed on a back surface of the first liquid crystal panel, the image processing method comprising:
generating the first image from an input image in which a fourth image is overlapped on a third image, an image in a first region included in the first image forming the fourth image;
generating the second image from the input image, an image in a second region included in the second image forming the fourth image; and
reducing a luminance in the second region in the second image to reduce the luminance of the fourth image, with an amount of reduction of the luminance in the second region being larger than an amount of reduction of a luminance in the first region.
